(19) United States
(12) Patent Application Publication
(10) Pub. No.: US 2007/0194653 A1
(43) Pub. Date: Aug. 23, 2007

(54) Primary Element For An Electrical Machine

(76) Inventors: Joachim Prokscha, Buehl (DE); Heiko Sponar, Rastatt (DE); Juergen Tempel, Baden-Baden (DE); Michael Huber, Rheinmuenster (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/591,861

(22) PCT Filed: Jan. 31, 2005
(86) PCT No.: PCT/EP05/50381

§ 371 Date: Sep. 6, 2006

(30) Foreign Application Priority Data
Mar. 6, 2004 (DE) 10 2004 011 094.8

(51) Int. Cl. H02K 3/34; H02K 1/28; H02K 1/12

(52) U.S. Cl. 310/218; 310/215; 310/259; 310/254

(57) ABSTRACT

A primary element for an electrical machine has a magnetically conductive body including a lamination stack with a plurality of axially extending teeth disposed in a star pattern, and a winding of annular coils wound separately as coil-body-less air coils and mounted radially onto the teeth. To attain an axially and radially play-free seat of the annular coils on the teeth, on each face end of the magnetically conductive body, one compensation element, which is elastically deformable in the axial direction of the tooth, is placed on each of the face ends, located in a transverse plane to the body axis, of the teeth, onto which compensation element the annular coil slipped onto the tooth is pressed axially. All the compensation elements on one face end are joined together via a closed ring element to make a one-piece compensation mask of insulating plastic.

### PRIOR ART

The invention is based on a primary element for an electrical machine as generically defined by the preamble to claim 1.

In a known stator as a primary element of an internal rotor motor (German Utility Model DE 299 16 605 U1), the magnetically conductive body is put together from two lamination packets, which are layered from individual lamination blanks. One lamination blank has a receiving opening for the rotor, with an opening edge over whose circumference a number of swallowtail-like joining slots are embodied equidistantly. These lamination blanks are placed axially on one another and made into a packet to form a hollow-cylindrical short-circuit yoke. A further lamination blank has a tooth strut with a swallowtail-like tooth foot and one tooth head or tooth shoe protruding past the tooth strut. These lamination blanks are put into packets to make tooth portions of axial teeth. A third lamination blank has a number, corresponding to the number of joining slots, of identical tooth struts, disposed in a star pattern and having swallowtail-like tooth feet and tooth heads or tooth shoes, the tooth heads or tooth shoes of which are joined together via thin struts extending in the circumferential direction. In making a packet of the tooth portions, such lamination blanks are placed in the tooth packet axially spaced apart and are disposed on the two outer face ends of the tooth packet. As a result of these lamination blanks, the stamped packet of teeth, called a stator star, is given a stable form.

The stator winding of the known stator has a number of elongated annular coils, corresponding to the number of teeth, which are wound onto coil bodies and thrust radially onto the teeth of the stator star. After that, the stator yoke is placed on its face end onto the stator star, which is provided with the stator winding, and the feet of the teeth in the stator star are thrust by positive engagement into the joining slots in the short-circuit yoke.

It is also known to produce the annular coils of the stator winding in coil-body-less fashion as so-called air windings and to place them in the same way on the teeth of the stator star; an electrical insulation in the form of inserted paper strips or a coating of the teeth is provided between the air coil and the teeth. Such air coils simplify the winding process and make a higher slot fill factor possible in the slots of the stator that are enclosed by the teeth. So that the annular coils are held nondisplaceably on the teeth in the axial and radial directions, close tolerances with regard to the internal dimensions of the annular coils, the so-called window of the annular coils, and the height of the packet forming the stator star must be adhered to both in production of the annular coils and in packeting the stator star.

### ADVANTAGES OF THE INVENTION

The primary element according to the invention for an electrical machine, having the characteristics of claim 1, has the advantage that because of the at least one compensation mask, placed on one and preferably both face ends of the magnetically conductive body, which mask with its compensation elements covers the face ends of the teeth, the annular coils are axially nondisplaceably fixed on the teeth without having to maintain close tolerances between the window dimensions of the annular coils and the packet height of the magnetically conductive body. The tolerance compensation for a firm seat of the annular coils on the teeth is-accomplished-by means of the spring-travel of the axially elastically deforming compensation elements, which are axially compressed more or less severely as they are placed on the annular coils. At the same time, by means of the compensation elements, an electrical insulation of the coil heads of the annular coils from the teeth and protection of the annular coils against mechanical damage from the tooth edges are accomplished.

By means of the compensation masks mounted on both face ends of the magnetically conductive body, the annular coils are additionally fixed centrally to the teeth, and the stability of the magnetically conductive body is increased, which is advantageous for the process of installing the winding.

By the provisions recited in the further claims, advantageous refinements of and improvements to the primary element defined by claim 1 are possible.

In one advantageous embodiment of the invention, parallel ribs are embodied on the outer face, facing away from the tooth, of the compensation elements and are disposed one above the other, spaced apart from one another, in the radial direction of the tooth. By means of these ribs, which in the coil head reach between the wire windings of the annular coils, a play-free fixation of the annular coils in the radial direction is achieved.

In an advantageous embodiment of the invention, the ring element, which joins the compensation elements associated with the teeth together into a compensation mask, is formed by a preferably thin-walled annular sleeve, from whose outer wall the compensation elements protrude in a star pattern. The annular sleeve has a protruding portion, which protrudes axially-past the compensation-elements and which, when annular-coils have been placed on the teeth, covers the underside of the coil heads of the annular coils. By means of this protruding portion, the stability of the winding is reinforced in the region of the coil heads.

In an advantageous embodiment of the invention, one insulation strip each is placed on the one hand between the long sides, facing away from one another, of the teeth and on the other between the inner long sides, oriented toward the aforementioned long sides, of the annular coils slipped onto the teeth, as a result of which a complete electrical insulation is achieved between the annular coils and the teeth. The insulation strips are preferably secured to the inner long sides, facing one another, of the annular coils, in particular glued on, and as a result are positioned automatically in the course of the installation of the annular coils onto the teeth.

In an advantageous embodiment of the invention, the insulation strips are angled, on the top side pointing outward of the annular coils, for the sake of covering these annular coils, so that the annular coils are also electrically insulated from a hollow-cylindrical short-circuit yoke that is later thrust onto the free outer face of the teeth.

### DRAWING

The invention is described in further detail in the ensuing description in terms of an exemplary embodiment shown in the drawing. Shown are:

FIG. 1, a top view in perspective of a compensation mask;

FIG. 2, in perspective, a stator star of a stator with compensation masks mounted on both face ends;

FIG. 3, the same view as in FIG. 2, with annular coils mounted on some teeth;

FIG. 4, an enlarged top view of the detail marked IV in FIG. 3;

FIG. 5, a perspective view of an end-mounted stator.

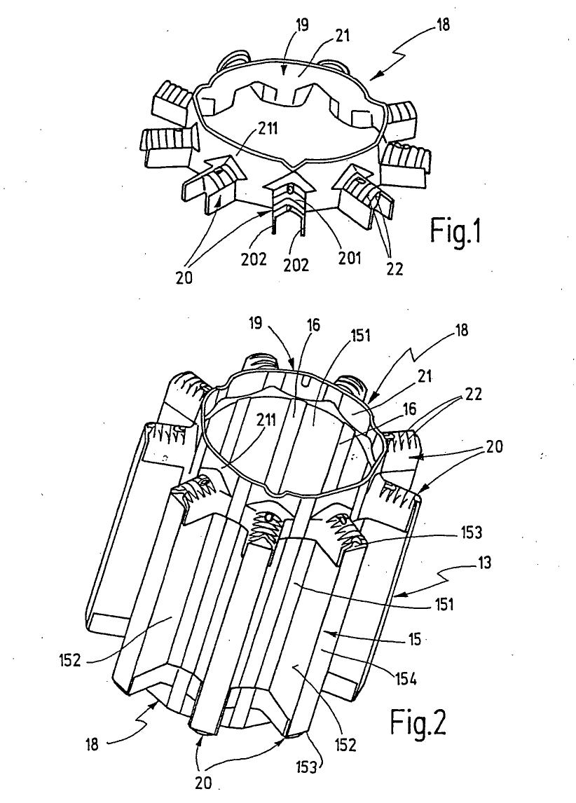

### DESCRIPTION OF THE EXEMPLARY EMBODIMENT

The primary element for an electrical machine will now be described taking as an example a stator of a direct current motor with an internal rotor. The stator 10 (FIG. 5) has a magnetically conductive body, known as a stator body 11, which in a known manner comprises a plurality of sheet-metal laminations put together into a lamination packet, and a stator winding 12, for easier application of the stator winding 12 to the stator body 11, the stator body 11 is split and is put together from a so-called stator star 13 and a hollow-cylindrical short-circuit yoke 14 surrounding the stator star 13 on the outside; both the stator star 13 and the short-circuit yoke 14 are embodied of coil bodies made from sheet-metal laminations resting on one another.

The stator star 13 has a plurality of radially oriented, longitudinally extending teeth 15, disposed in a star pattern, on the inward-pointing ends-of-which, tooth shoes 151 are embodied, protruding in a circumferential direction on both sides past the tooth 15. The tooth shoes 151 of what in this exemplary embodiment is a total of nine teeth 15 are joined together via radially narrow struts 16. One lamination blank or one lamination of the stator star 13 thus comprises nine teeth 15 with tooth shoes 151 embodied on them and nine struts 16, which are joined integrally to the tooth shoes 151. Depending on the desired axial length or packet height of the stator star 13, as many lamination blanks as needed are put together to make the stator star 13; in terms of packet height, the stator star 13 has a tolerance range of approximately 1.5 thicknesses of the metal sheets. The stator winding 12 comprises interlocking, elongated, oval annular coils 17, which are wound in a coil winder as coil-body-less air coils separately from the stator body 11. One annular coil 17 is placed radially on each tooth 15, so that the number of annular coils 17 is equal to the number of teeth 15, and thus in this exemplary embodiment is nine.

For the stator 10, it is of substantial importance that the annular coils 17 be fixed axially and radially nondisplaceably on the teeth 15 and that no play occur in this direction that would put a mechanical burden on the switching connections between the annular coils 17, which over the long term would cause breakage of the switching connections and thus failure of the stator winding 12. The internal dimensions of the annular coils, also called coil windows, must therefore be adapted to very precise tolerances to the dimensions of the teeth 15, so that a firm seat of the annular coils 17 on the teeth 15 is assured. However, because of the range of tolerance of the packet height of the stator star 13, this kind of play-free seat of the annular coils 17 can be achieved only with difficulty.

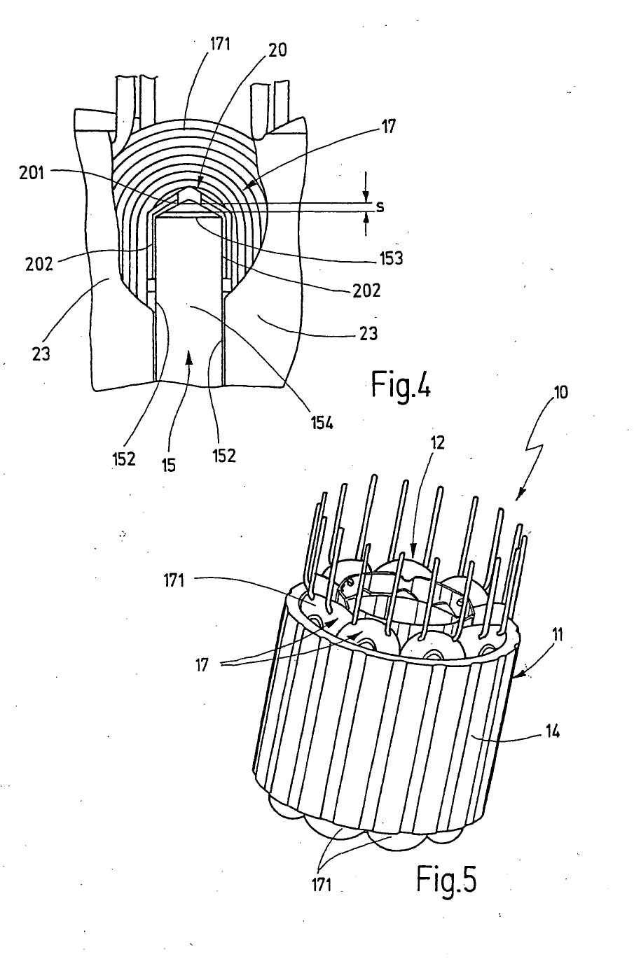

To provide a remedy for this, one compensation mask 18, shown in perspective in FIG. 1, made of electrically insulating material is mounted on each face end of the stator star 13. Each compensation mask 18 has a number of compensation elements 20 corresponding to the number of teeth, these elements being elastically deformable in the axial direction of the teeth 15, and one closed ring element 19 joining the compensation elements 20 to one another. The ring element 19 and the compensation elements 20 are produced as a one-piece plastic injection-molded part. Each compensation element 20 is approximately U-shaped, with a transverse strut 201 embodied in gabled fashion and two legs 202 of the U that extend in one piece from the transverse strut 201. The ring element 19 is embodied as a thin-walled annular sleeve 21, from whose outer wall the U-shaped compensation elements 20 protrude in a star pattern; the annular sleeve 21 has a protruding portion 211 that protrudes axially past the radially oriented transverse struts 201 of the compensation elements 20. When the compensation mask 18 is mounted on the face ends of the stator star 13, one compensation element 20 is placed on each tooth 15, so that the face end of the tooth 15 is spanned by the gable-like transverse strut 201, and the short legs 202 of the U are pushed onto the two long sides 152, facing away from one another, of the teeth 15. As can be seen clearly in FIG. 4, when compensation elements 20 are mounted on the teeth 15, there is a spring travels between the face end 153 of the tooth 15 and the gable-like transverse strut 201 of the compensation element 20, by the length of which the compensation element 20 can be pressed inward elastically in the axial direction of the teeth 15. This spring travel s determines the tolerance range that the compensation mask 18 is capable of compensating for relative to the length of the teeth 15, or in other words the packet height of the stator star 13. On the outer face, remote from the face end 153, of one tooth 15 of each compensation element 20, parallel ribs 22 are embodied, spaced apart one above the other in the radial direction. The ribs 22 are shaped in one piece out of the gable-like transverse strut 201.

Once the two compensation masks 18 have been mounted on the stator star 13, the individual annular coils 17 are pushed radially onto the teeth 15, and depending on the existing tolerances between the axial length of the teeth 15 and the clearance length of the coil windows of the annular coils 17, the transverse struts 201 of the compensation elements 20 are pressed inward more or less toward the face end 153 of the teeth 15 by the coil heads 171. Thus by their spring restoring force of the compensation elements 20, the annular coils 17 are fixed by nonpositive engagement and axially without play on the teeth 15. The ribs 22 embodied on the transverse struts 201 of the compensation elements 20 reach between the individual windings in the coil heads 171 of the annular coils 17 and thus prevent a radial motion of the annular coils 17 onto the teeth 15. The coil heads 171 of the annular coils 17 rest on the protruding portion 211 of the annular sleeve 21, which contributes to increased stability of the stator winding 12.

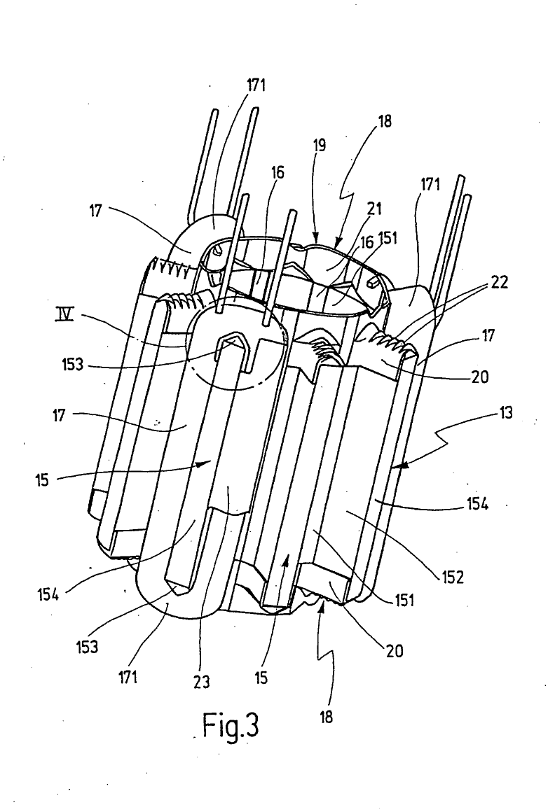

For further insulation of the annular coils 17 from the teeth 15, one insulation strip 23 is placed on the one hand between the long sides 152, facing away from one another, of the teeth 15 and on the other between the inner long sides, facing toward the aforementioned long sides, of the annular coils 17 thrust onto the teeth 15, as indicated in FIGS. 3 and 4. The insulation strips 23 are secured to the inner long sides, facing toward one another, of the annular coils 17, preferably being glued on, so that when the annular coil 17 is mounted on the teeth 15, the insulation strips are automatically positioned correctly. The insulation strips 23 are angled at the point of exit from the annular coil 17 and cover the outward-pointing tops of the annular coils 17.

The hollow-cylindrical short-circuit yoke 14 is thrust axially onto the stator star 13 that has thus been provided with annular coils 17, and the radially outward-pointing tooth faces 154 rest by positive engagement on the inner wall of the short-circuit yoke 14. By means of the insulation strips 23 protruding past the tops of the annular coils 17, the annular coils 17 are also electrically insulated from the short-circuit yoke 14.

The invention is not limited to the primary element, described as a stator, for an electrical machine. In the same way, the primary element may be embodied as a rotor, for instance of a direct current motor with an external rotor.

1-13. (canceled)

14. A primary element for an electrical machine, comprising
a magnetically conductive body assembly from laminations resting axially on one another and having a plurality of axially extending teeth disposed in a star pattern,
a winding of individual annular coils which are wound separately as coil-body-less air coils and thrust radially onto the teeth,
a compensation element on at least one face end of the magnetically conductive body, the compensation element being elastically deformable in the axial direction of the tooth and being placed onto each of the face ends, located in a transverse plane to the body axis, of the teeth, and the annular coil which is thrust onto the tooth being pressed axially onto the at least one compensation element; and
a closed ring element joining all the compensation elements together to make a compensation mask.

15. The primary element as defined by claim 14, wherein one compensation mask is provided on each face end of the magnetically conductive body.

16. The primary element as defined by claim 14, further comprising parallel ribs embodied on the outer face, facing away from the tooth, of the compensation elements, the ribs being disposed one above the other and spaced apart from one another in the radial direction of the tooth.

17. The primary element as defined by claim 15, further comprising parallel ribs embodied on the outer face, facing away from the tooth, of the compensation elements, the ribs being disposed one above the other and spaced apart from one another in the radial direction of the tooth.

18. The primary element as defined by claim 14, wherein the compensation element has the shape of a U with a transverse strut embodied in gable-like fashion and two short legs of the U integrally extending from the transverse strut; and wherein the transverse strut covers the face end of the tooth, and the legs of the U reach over the long sides, facing away from one another, of the tooth.

19. The primary element as defined by claim 15, wherein the compensation element has the shape of a U with a transverse strut embodied in gable-like fashion and two short legs of the U integrally extending from the transverse strut; and wherein the transverse strut covers the face end of the tooth, and the legs of the U reach over the long sides, facing away from one another, of the tooth.

20. The primary element as defined by claim 16, wherein the compensation element has the shape of a U with a transverse strut embodied in gable-like fashion and two short legs of the U integrally extending from the transverse strut; and wherein the transverse strut covers the face end of the tooth, and the legs of the U reach over the long sides, facing away from one another, of the tooth.

21. The primary element as defined by claim 18, wherein the ribs are shaped in one piece from the gable-like transverse strut.

22. The primary element as defined by claim 18, wherein the gable-like transverse strut is embodied such that between the gable faces and the face end of the tooth, a spring travel is present for resilient retraction of the transverse strut.

23. The primary element as defined by claim 21, wherein the gable-like transverse strut is embodied such that between the gable faces and the face end of the tooth, a spring travel is present for resilient retraction of the transverse strut.

24. The primary element as defined by claim 14, wherein the ring element is formed by a preferably thin-walled annular sleeve, from whose outer wall the compensation elements protrude in a star pattern.

25. The primary element as defined by claim 24, wherein the annular sleeve comprises a protruding portion, which protrudes axially past the transverse struts of the compensation elements and which, when annular coils have been placed on the teeth, covers the undersides of the coil heads of the annular coils.

26. The primary element as defined by claim 24, wherein the annular sleeve and the compensation elements are made in one piece as a plastic injection-molded part.

27. The primary element as defined by claim 25, wherein the annular sleeve and the compensation elements are made in one piece as a plastic injection-molded part.

28. The primary element as defined by claim 14, further comprising one insulation strip each resting on the one hand between the long sides, facing away from one another, of the teeth and on the other between the inner long sides, oriented toward the aforementioned long sides, of the annular coils pressed onto the teeth.

29. The primary element as defined by claim 15, further comprising one insulation strip each resting on the one hand between the long sides, facing away from one another, of the teeth and on the other between the inner long sides, oriented toward the aforementioned long sides, of the annular coils pressed onto the teeth.

30. The primary element as defined by claim 16, further comprising one insulation strip each resting on the one hand between the long sides, facing away from one another, of the teeth and on the other between the inner long sides, oriented toward the aforementioned long sides, of the annular coils pressed onto the teeth.

31. The primary element as defined by claim 28, wherein one insulation strip is secured, preferably glued on, to each of the inner long sides, oriented toward one another, of the annular coils.

32. The primary element as defined by claim 28, wherein the insulation strips are angled, on the top side pointing outward of the annular coils, for the sake of covering these annular coils.

33. The primary element as defined by claim 14, wherein the magnetically conductive body comprises a hollow-cylindrical short-circuit yoke, which is slipped onto the outward-pointing, free tooth faces of the teeth equipped with the annular coils.
